(19) United States
(12) Patent Application Publication
(10) Pub. No.: US 2006/0181105 A1
(43) Pub. Date: Aug. 17, 2006

(54) Display element for use for a passenger seat

(75) Inventor: Carsten Puschmann, Hamburg (DE)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Airbus Deutschland GmbH, Hamburg (DE)

(21) Appl. No.: 11/334,325

(22) Filed: Jan. 18, 2006

Related U.S. Application Data
(60) Provisional application No. 60/645,345, filed on Jan. 20, 2005.

(30) Foreign Application Priority Data
Jan. 20, 2005 (DE) 10 2005 002 790.3

(51) Int. Cl. B60N 2/02; G09F 1/00; G09F 3/10; G09F 7/00; G06F 1/16; G08B 3/00; G08B 23/00

(52) U.S. Cl. 296/65.01; 340/691.6; 340/693.9; 40/299.01; 40/124.01; 40/584; 361/681

(57) ABSTRACT

A display element for use for a passenger seat may be integratable into the backrest (or armrest) of the passenger seat in order to be able to be observed from the rear of the passenger seat.

### CROSS-REFERENCE TO RELATED APPLICATIONS

This application claims the benefit of the filing date of Provisional Patent Application No. 60/645,345 filed Jan. 20, 2005, the disclosure of which is hereby incorporated herein by reference.

### BACKGROUND OF THE INVENTION

The present invention relates to a display element for use for a passenger seat, in particular for a passenger seat which is positioned in seat rows in an aircraft.

A display element which is used in an aircraft, for example, is the “Fasten Seat Belt” sign or the “No Smoking” sign. These display elements are typically arranged below the hand luggage storage (hatracks) directly above the passenger seats.

In novel designs of aircraft cabins, it may occur that the distance between the passenger seat and the bottom of the hatrack is larger than is currently typical, so that the “Fasten Seat Belt” sign and the “No Smoking” sign are further away from the passenger. The signs are more difficult to recognize for the passenger than with conventional hatrack installations.

### SUMMARY OF THE INVENTION

According to an exemplary embodiment of the invention, a possibility is provided for bringing the display elements closer to the passenger independently of the position of the hatrack.

According to an exemplary embodiment of the invention, a display element may be integratable into a backrest of a passenger seat. The display element may be integratable into the backrest of the passenger seat in such a way that the display element may be observed from the rear of the passenger seat. A person sitting behind it may thus read the display element which is integrated into the backrest of the seat in front without problems.

A display element according to an exemplary embodiment of the invention may be integratable into the backrest at a position above a folding table arranged at the backrest. The display element may be approximately at the eye height of a person sitting in a passenger seat which is positioned behind the passenger seat in whose backrest the display element may be integrated.

The display element may be, for example, an information sign, on which “Fasten Seat Belt” and/or “No Smoking” is placed. A display element may have multiple information signs of this type, having different inscriptions adapted in accordance with the application, multiple information signs being integrated with one another into one unit according to one exemplary embodiment. According to another example, the display element may have multiple information signs which are implemented independently of one another and may be integrated into a backrest of a passenger seat.

According to an exemplary embodiment of the invention, the display element may be a display, such as an LCD display, which is electronically programmable in order to be able to display different information flexibly.

According to an exemplary embodiment of the invention, a solution may be created in which, for example, the “Fasten Seat Belt” sign and the “No Smoking” sign are positioned in an efficient manner or optimally in the field of vision of the passenger in an aircraft and may always be recognized well. The installation of the “Fasten Seat Belt” sign and the “No Smoking” sign may be independent of the hatrack design, according to an exemplary embodiment of the invention. Therefore, the degree of freedom for the cabin design may become greater.

Because of the implementation of the display element as a display, a new component does not have to be produced if symbols of the display element are changed. Using a standard component and appropriately adapted software, all necessary symbols may be produced on the display. All displays in an aircraft may be produced using the same component. Changes may even be performed at a later time without problems, the display also being able to be used for other displays which have not currently been implemented, for example, for a “stow table” sign. Furthermore, the display element which is implemented as a display may store temporary information, such as changing advertising overlays.

It is also possible according to an exemplary embodiment of the invention to change over flexibly and easily between different languages.

### BRIEF DESCRIPTION OF THE DRAWINGS

Exemplary embodiments of the invention will be explained in detail in the following with reference to the attached drawing.

### BRIEF DESCRIPTION OF THE DRAWINGS

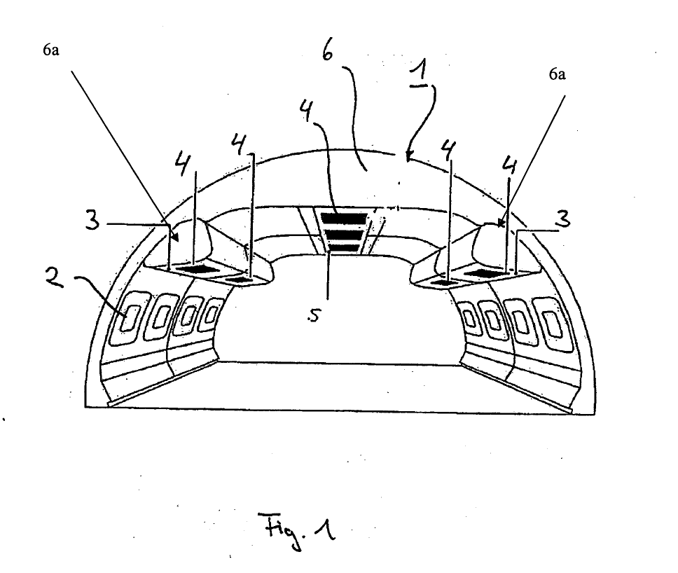

FIG. 1 shows a schematic illustration of an aircraft cabin (detail);

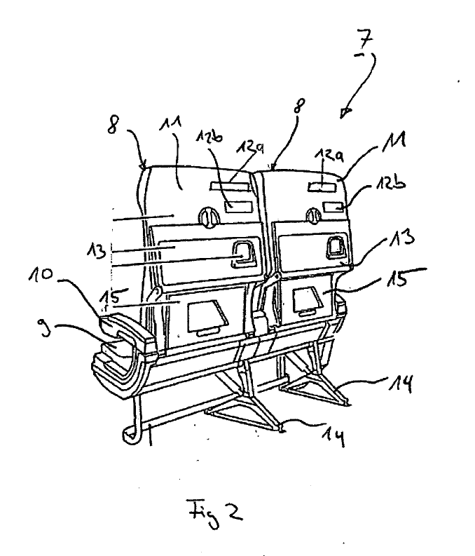

FIG. 2 shows a perspective view of two passenger seats having integrated display elements according to an exemplary embodiment of the present invention from the rear; and

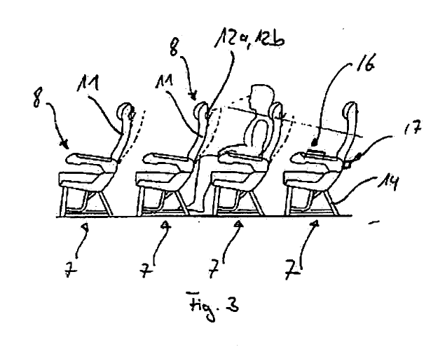

FIG. 3 shows a schematic view of multiple passenger seats having integrated display elements according to an exemplary embodiment of the present invention from the side.

### DETAILED DESCRIPTION

In the following, identical elements are provided with identical reference numbers in the figures.

FIG. 1 shows a schematic illustration of an aircraft cabin (detail) 1. Above windows 2, channels 3 (lateral service channels) running in the longitudinal direction of the aircraft fuselage are positioned on baggage storage spaces 6a of the aircraft cabin 1. PSIUs (passenger service information units), which contain displays for “No Smoking” or “Fasten Seat Belts”, are positioned on the bottom of the channels 3.

In novel designs of aircraft cabin, a central service channel 5, which has essentially the identical function and object as the lateral service channels 3, is located directly in the ceiling of the aircraft cabin 1, running between the lateral service channels 3 in the longitudinal direction of the aircraft fuselage. The central service channel 5 also comprises multiple PSIUs 4 positioned in the longitudinal direction of the aircraft fuselage.

Typically, multiple seat rows positioned in the longitudinal direction of the aircraft fuselage (not shown in FIG. 1) are mounted directly under the lateral service channels 3 and under the central service channel 5. The PSIUs 4 of the lateral service channels 3 and the central service channel 5 generally contain display elements such as the “Fasten Seat Belt” sign and the “No Smoking” sign for each seat and/or seat row.

In the novel design of an aircraft cabin 1 shown in FIG. 1, the problem arises, particularly in the passenger seats directly below the central service channel 5, that passengers may not read the display elements well in the PSIUs 4 which are positioned above them because of the distance. The display elements are further from the passenger since the service channel 5 is integrated directly into the ceiling 6 of the aircraft cabin 1.

FIG. 2 shows a seat row 7 having two passenger seats 8, which may be positioned directly below the central service channel 5 according to FIG. 1, for example.

FIG. 2 shows a passenger seat 8 having a seat surface 9, an armrest 10, and a backrest 11. The cover of the backrest is cut out appropriately to receive display elements 12 in an upper area of the backrest 11. According to the preferred exemplary embodiment, for example, a “Fasten Seat Belt” sign 12a and a “No Smoking” sign 12b are integrated separately as separate components into the backrest 11 of the passenger seat 8.

As shown in FIG. 2, the display elements 12a, 12b are located, for example, above a folding table 13 which is shown folded against the backrest 11 in FIG. 2. The display elements 12a, 12b are thus located essentially at the eye height of a person sitting behind them and may be perceived well by this person.

In FIG. 2, the display elements 12a, 12b are shown as separate components which are integrated into the backrest 11 of the passenger seat 8 separately from one another.

The display elements 12a and 12b may also be contained in a unit which may be integrated into the backrest 11 of the passenger seat 8.

The display elements 12a and 12b may also be implemented as an electronic display, such as an LCD display, the display being programmable in order to be able to display greatly varying information.

FIG. 2 also shows devices 14 below a foot rest 15 to attach the passenger seat 8 and/or the seat row 7 to the floor of the aircraft cabin 1, as shown in FIG. 3.

FIG. 3 shows four seat rows 7 from the side. The seat rows 7 are positioned below the lateral service channels 3 and/or below the central service channel 5 in such a way that a PSIU 4 is located directly in front of each passenger seat 8 and/or a passenger seat row 7.

According to the present invention, the PSIU 4 no longer needs to contain a display element, since this is integrated into the backrest 11 of the passenger seat 8, as shown in FIG. 3. Alternatively, the PSIU 4 may still contain display elements, which may also be implemented as a display, for example, as discussed above.

As shown in FIG. 3, the display element 12a, 12b is preferably located in the field of vision of a person seated in a passenger seat 8, behind the passenger seat 8 in whose backrest 11 the display element 12 is integrated.

As indicated by the dashed line in FIG. 3, the backrest 11 may recline. In order that the display unit integrated into the backrest 11 of the front seat remains in the field of vision of a person sitting behind it, the display element 12 may be pivotable, for example. This may be performed automatically as a function of the position of the backrest in which the display element is integrated or manually by a person sitting behind it.

Reference number 16 identifies a further exemplary embodiment of the present invention. As may be seen from FIG. 3, the display element 16 is integrated into the armrest of the seat. The display element 16 is preferably integrated and/or installed in the top of the armrest. The top of the armrest is the side which points upward when the armrest is in an essentially horizontal position. The display element may also be positioned on the side of the armrest facing toward the seat surface; or in another visible area of the armrest. The display element is preferably designed to display a “Fasten Seat Belt” statement and a “No Smoking” statement (also in a different language).

Armrests of aircraft seats may be implemented as fixed, for example, essentially in a horizontal position. If the display element is positioned in the top of the armrest, both the person in the seat to which the armrest belongs and also a person on a possibly provided neighboring seat may see the display.

The armrests may also be implemented as foldable. In such a case, for example, depending on the position of the armrest (folded up or essentially horizontal), the display on the display element 16 is recognizable by the person in the seat having the armrest (with the armrest essentially horizontal) or by a person in a seat behind the seat (when the armrest is folded up). Therefore, efficient signaling may be achieved. A corresponding display unit, as indicated by reference number 17, for example, may also be attached to an area of the armrest pointing to the rear in such a way that the display unit is visible to one or more persons in seats behind the armrest.

The arrangement of the display elements in the backrest and on the armrest may be combined, of course, through which better signaling may be achieved.

Although the present invention was described in detail in the preceding with reference to the attached drawing, it is obvious that modifications and alterations may be performed without leaving the protective scope of the present invention. For example, a display element may be provided in order to display appropriate information for multiple passenger seats or the entire seat row located behind it. Furthermore, application of the present invention in areas other than aircraft is possible, for example, in buses, ships, etc.

Furthermore, it is to be noted that “comprising” does not exclude other elements or steps and “a” or “an” does not exclude multiples. In addition, it is to be noted that features or steps which have been described with reference to one of the above exemplary embodiments may also be used in combination with other features or steps of other exemplary embodiments described above. Reference numbers in the claims are not to be viewed as a restriction.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A display element for use for a passenger seat, wherein the display element is integratable into a backrest of the passenger seat.

2. The display element of claim 1, wherein the display element which is integratable into the backrest is observable from the rear of the passenger seat.

3. The display element of claim 1, wherein the display element which is integratable into the backrest is at a position above a folding table arranged at the backrest.

4. The display element of claim 1, wherein the display element comprises a plurality of information signs which are integrated with one another into a unit.

5. The display element of claim 1, wherein the display element comprises a plurality of information signs which are implemented independently of one another.

6. The display element of claim 4, wherein the information sign is at least one of the group consisting of a “Fasten Seat Belt” sign and a “No Smoking” sign.

7. The display element of claim 1, wherein the display element is a display.

8. The display element of claim 7, wherein the display is an electronic LCD display.

9. The display element of claim 7, wherein the display is programmable to display information.

10. A passenger seat, comprising a display element of claim 1.

11. A display element for an aircraft seat, wherein the display element is adapted for use in an armrest of the aircraft seat.

12. The display element of claim 11, wherein the display element is adapted to display at least one of the group consisting of a “Fasten Seat Belt” instruction and a “No Smoking” instruction.

13. An aircraft seat comprising a display element of claim 1.
